(19) United States
(12) Patent Application Publication
(10) Pub. No.: US 2026/0248690 A1
(43) Pub. Date: Aug. 27, 2026

(54) VENTED CONTAINER FOR USE WITH A BOTTLE ASSEMBLY AND BOTTLE ASSEMBLY HAVING A VENTED CONTAINER

(71) Applicant: Dr. Brown's Company, St. Louis, MO (US)

(72) Inventors: Scott Rhodes, St. Louis, MO (US); Xiangwen Zhang, Ellisville, MO (US); Mark D. Reed, Columbia, IL (US)

(21) Appl. No.: 19/456,550

(22) Filed: Jan. 22, 2026

Related U.S. Application Data
(60) Provisional application No. 63/763,125, filed on Feb. 25, 2025.

(51) Int. Cl. A61J 9/04; A61J 9/00; A61J 11/00

(52) U.S. Cl. CPC A61J 9/04; A61J 9/005; A61J 11/008

(57) ABSTRACT

A container for a bottle assembly defines a liquid chamber and includes an exterior surface, an interior surface, a closed bottom, an open top, a side wall extending from the closed bottom, and at least one vent for allowing air to enter the liquid chamber upon vacuum pressure within the liquid chamber reaching a predetermined threshold.

### CROSS-REFERENCE TO RELATED APPLICATION

This application claims priority to U.S. Provisional Application Serial No. 63/763,125, filed on February 25, 2025, the contents of which are hereby incorporated by reference in their entirety.

### FIELD

The field of this invention relates generally to bottle assemblies and more particularly to a vented container for use with a bottle assembly and a bottle assembly have such a vented container.

### BACKGROUND

Bottle assemblies, such as infant or nursing bottle assemblies, typically have multiple components including a bottle, a nipple, a collar for securing the nipple to the bottle (the nipple and collar sometimes collectively referred to as a collar assembly), and a cap for covering the nipple when the bottle is not in use. The nipple typically has one or more openings for allowing liquid contained within the bottle to exit through the nipple and into an infant’s mouth for consumption by the infant (or young child). During use, the infant places an end of the nipple in their mouth and sucks on the nipple to withdraw the liquid contained within the bottle.

In some known nursing bottle assemblies, the bottle is a collapsible container. In such a configuration, the container is sufficiently flexible to allow it to compress into a more compact form when not in use or as liquid is withdrawn from the container such as when the infant sucks on the nipple. During use, assemblies with compressible containers are prone to becoming airlocked or otherwise difficult for the infant to drink therefrom because of increased vacuum within the container. Thus, liquid within the container may not flow from the container for consumption by the infant or young child, may flow sufficiently from the container, or otherwise becomes difficult for the infant to drink.

There is a need therefore for a bottle assembly with a compressible container that inhibits excessive vacuum pressure within the container.

### SUMMARY

In one aspect, a container for a bottle assembly defines a liquid chamber and generally comprises an exterior surface, an interior surface, a closed bottom, an open top, a side wall extending from the closed bottom, and at least one vent for allowing air to enter the liquid chamber upon vacuum pressure within the liquid chamber reaching a predetermined threshold.

In another aspect, a nursing bottle assembly generally comprises a container defining a liquid chamber and comprising an exterior surface, an interior surface, a closed bottom, an open top, a side wall extending from the closed bottom, and at least one vent for allowing air to enter the liquid chamber upon vacuum pressure within the liquid chamber reaching a predetermined threshold. A sleeve overlies and supports the container. A collar assembly is adapted for selective attachment to the sleeve for closing the nursing bottle assembly.

In yet another aspect, a container for a bottle assembly, the container defining a liquid chamber and comprising an exterior surface, an interior surface, a closed bottom, an open top, a side wall extending from the closed bottom, and at least one vent for allowing air to enter the liquid chamber upon vacuum pressure within the liquid chamber reaching a predetermined threshold, the predetermined threshold being between 2 millimeters of mercury vacuum pressure and 30 millimeters of mercury vacuum pressure.

### BRIEF DESCRIPTION OF THE DRAWINGS

FIG. 1 is a perspective view of one suitable embodiment of a nursing bottle assembly of the present disclosure.

FIG. 2 is an exploded view of the nursing bottle assembly.

FIGS. 3-5 are various side views of the nursing bottle assembly.

FIG. 6 is a side view of the nursing bottle assembly with a cap of the nursing bottle assembly spaced from the other components of the nursing bottle assembly.

FIG. 7 is a cross-section view of the bottle assembly taken along line 7-7 of FIG. 6.

FIG. 8 is a top view of the nursing bottle assembly as seen in FIG. 4.

FIG. 9 is a bottom view of the nursing bottle assembly as seen in FIG. 4.

FIG. 10 is a perspective view of a collapsible container of the bottle assembly of FIG. 1.

FIG. 11 is a cross-section view of the collapsible container taken along line 11-11 of FIG. 10.

FIG. 12 is an enlarged, fragmentary view of the collapsible container taken from an area of FIG. 11 to illustrate a duckbill valve (or more broadly a vent) disposed within the container.

FIG. 13 is an enlarged, fragmentary view of the collapsible container illustrating a shoulder, a neck, and a rim thereof.

FIG. 14 is an enlarged, fragmentary view of the collapsible container taken from area 14 of FIG. 13 with the illustrated duckbill valve being in a closed position.

FIG. 15 is an enlarged, fragmentary view similar to FIG. 14 but illustrating the duckbill valve in an opened position.

FIG. 16 is an enlarged, fragmentary view of the collapsible container taken from area 16 of FIG. 13.

FIG. 17 is a top view of the container.

FIG. 18 is a bottom view of the container.

FIG. 19 is a perspective view of a lower support of the nursing bottle assembly.

FIG. 20 is a side view of the lower support.

FIG. 21 is a front view of the lower support.

FIG. 22 is a top view of the lower support.

FIG. 23 is a bottom view of the lower support.

FIG. 24 is a perspective view of a sleeve of the nursing bottle assembly.

FIG. 25 is a side view of the sleeve.

FIG. 26 is a front view of the sleeve.

FIG. 27 is a top view of the sleeve.

FIG. 28 is a bottom view of the sleeve.

FIG. 29 is a perspective view of a collar of the nursing bottle assembly.

FIG. 30 is a side view of the collar.

FIG. 31 is a top view of the collar.

FIG. 32 is a bottom view of the collar.

FIG. 33 is a perspective view of a nipple of the nursing bottle assembly.

FIG. 34 is a side view of the nipple.

FIG. 35 is a top view of the nipple.

FIG. 36 is a bottom view of the nipple.

FIG. 37 is a cross-section view of the nipple taken along line 37-37 of FIG. 34.

FIG. 38 is a perspective view of a cap of the nursing bottle assembly.

FIG. 39 is a side view of the cap.

FIG. 40 is a front view of the cap.

FIG. 41 is a top view of the cap.

FIG. 42 is a bottom view of the cap.

FIG. 43 is a perspective view of another suitable embodiment of a nursing bottle assembly of the present disclosure.

FIG. 44 is an exploded view of the nursing bottle assembly seen in FIG. 43.

FIG. 45 is a perspective view of yet another suitable embodiment of a nursing bottle assembly of the present disclosure.

FIG. 46 is an exploded view of the nursing bottle assembly seen in FIG. 45.

FIG. 47 is a perspective view of still another suitable embodiment of a nursing bottle assembly of the present disclosure.

FIG. 48 is an exploded view of the nursing bottle assembly seen in FIG. 47.

Corresponding reference characters indicate corresponding parts throughout the several views of the drawings.

### DETAILED DESCRIPTION OF THE DRAWINGS

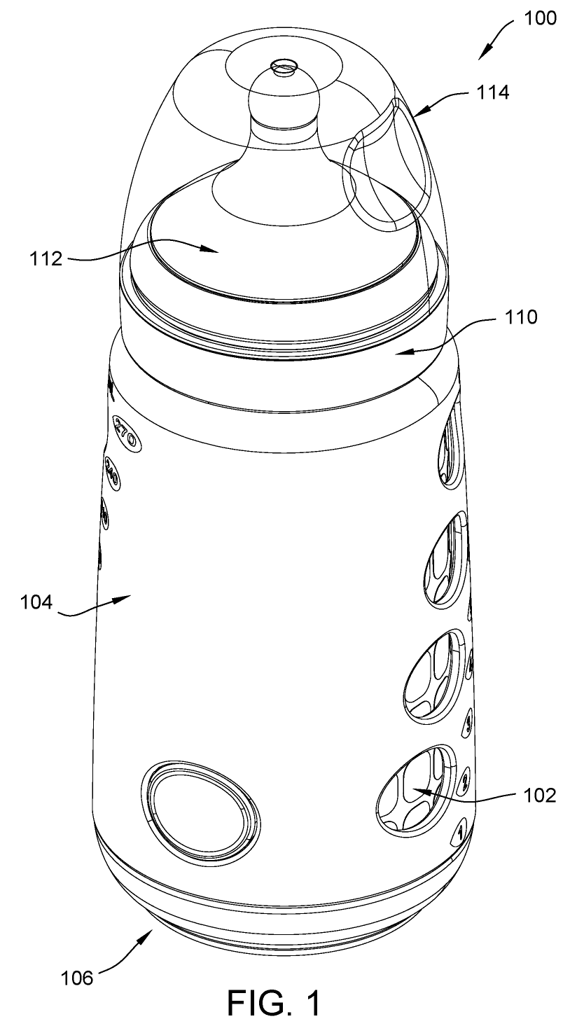

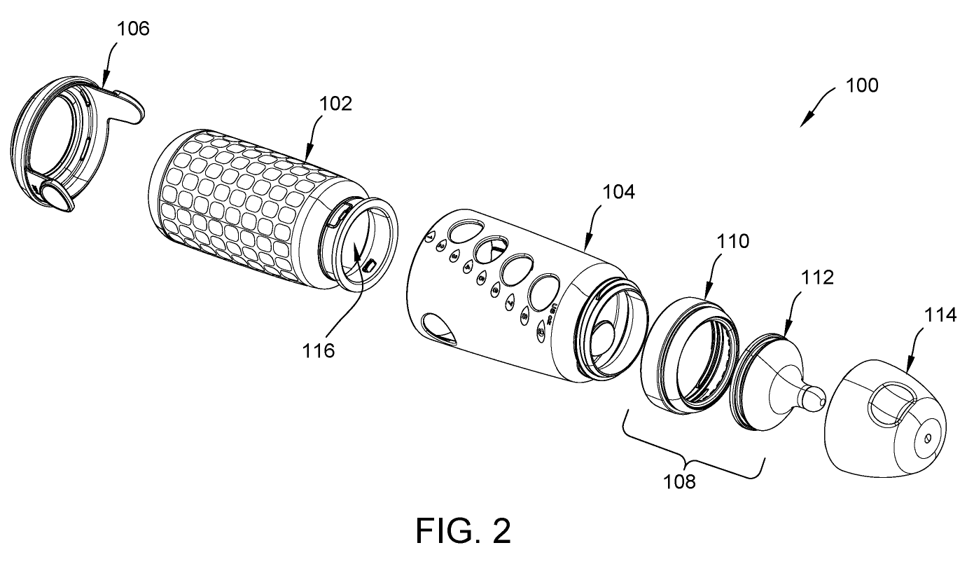

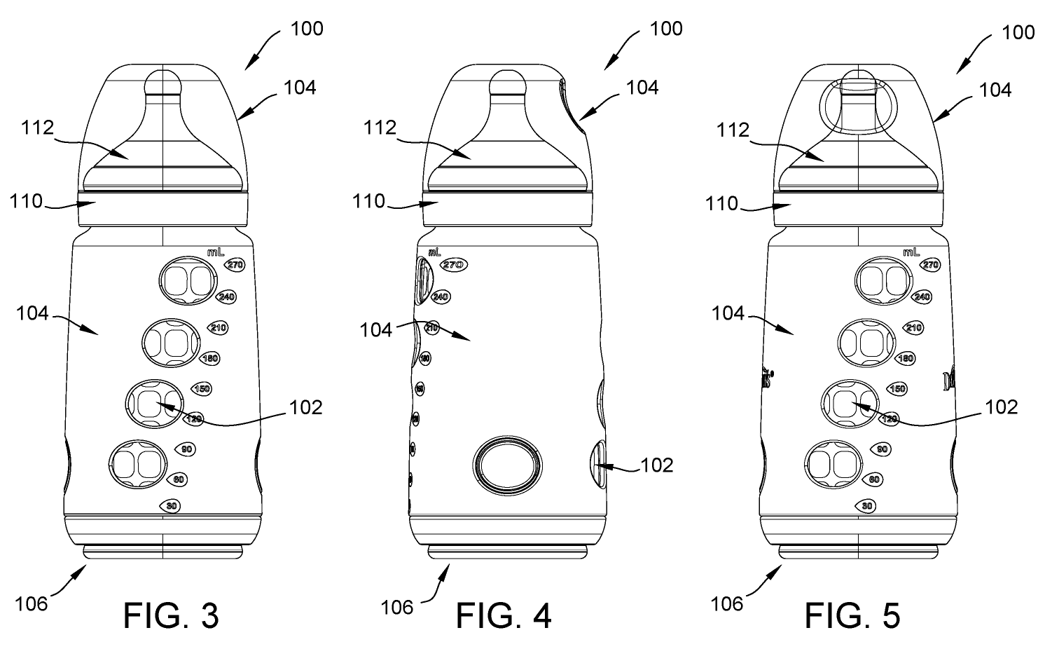

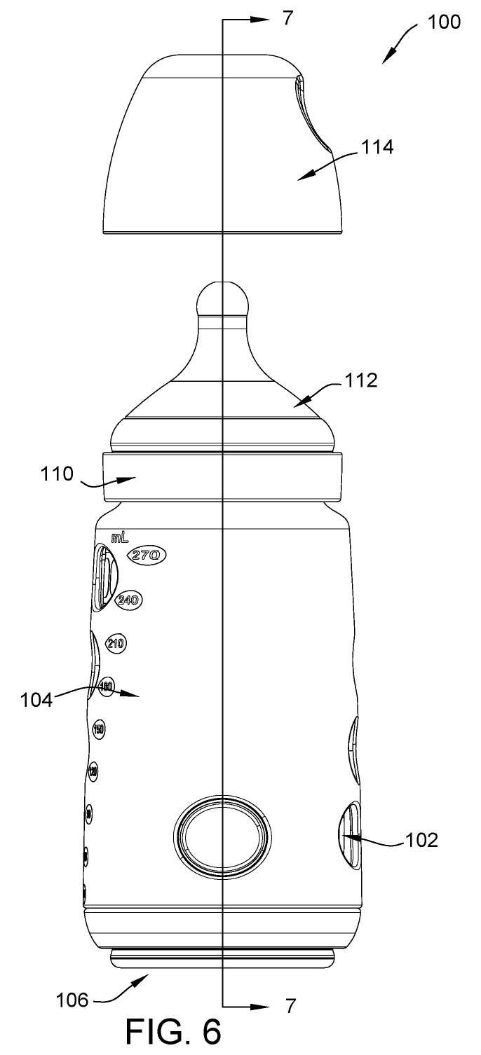

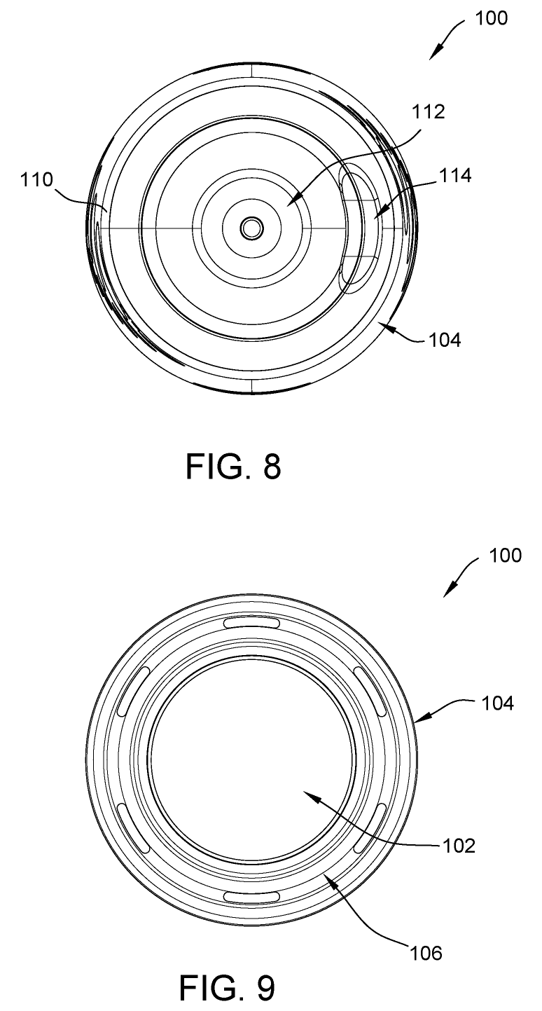

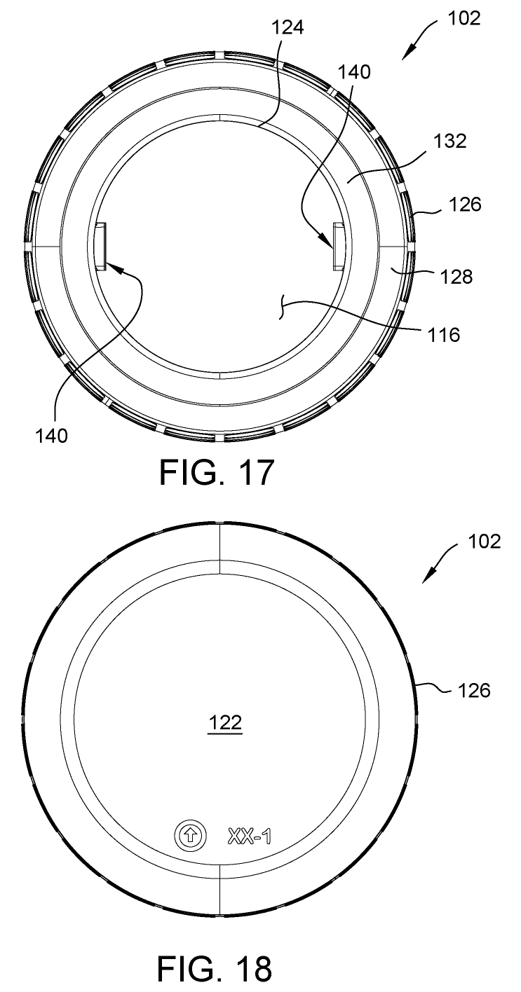

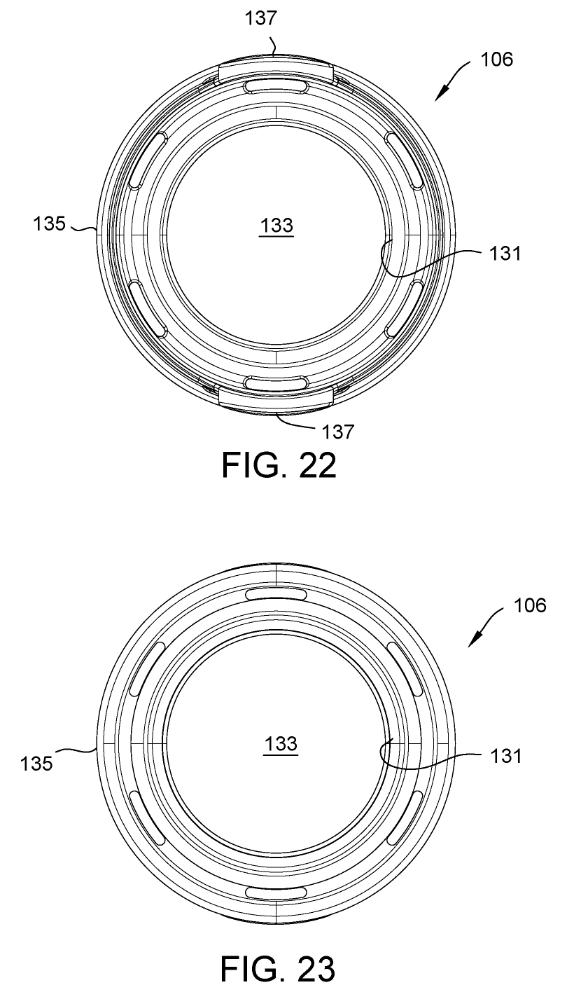

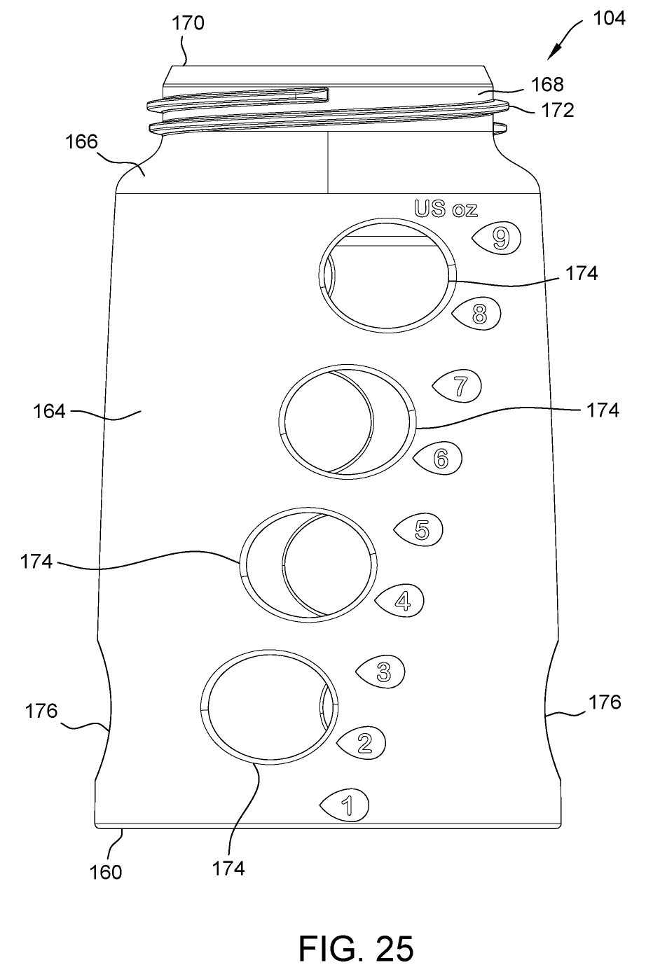

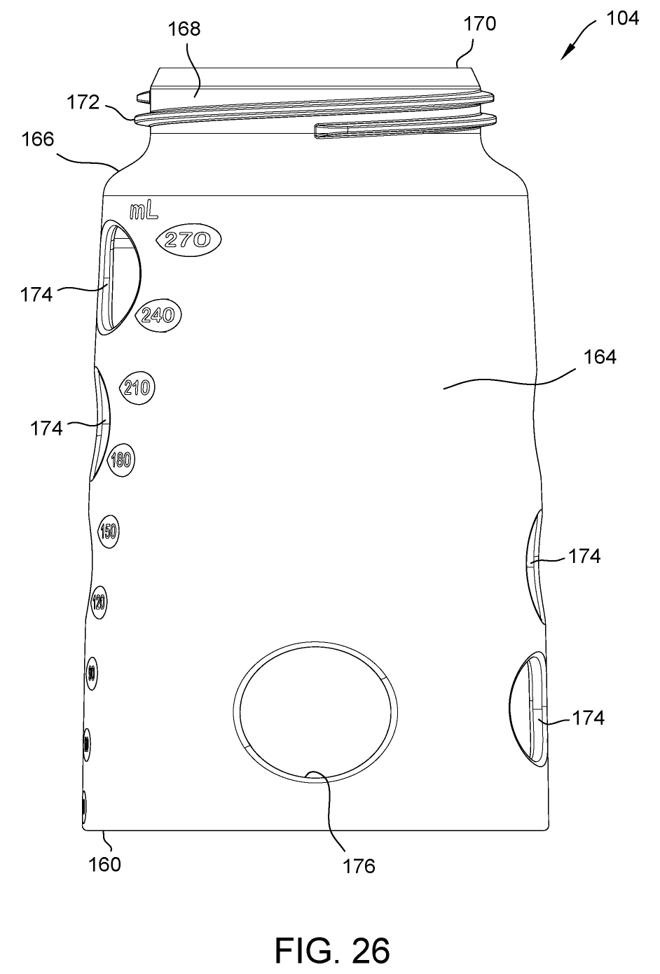

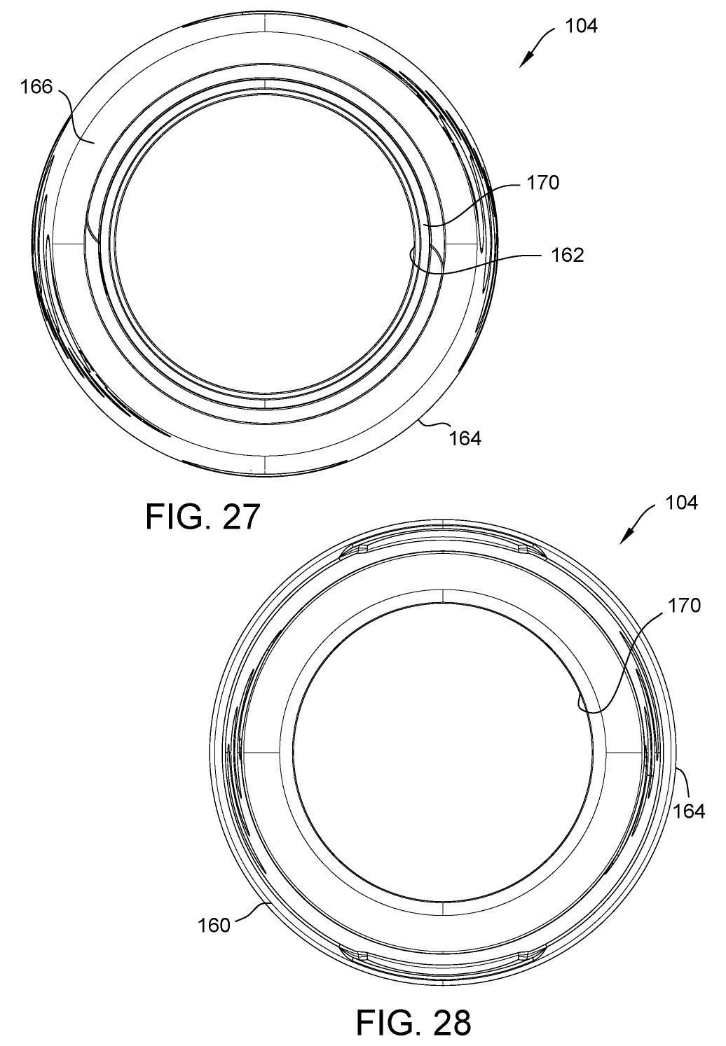

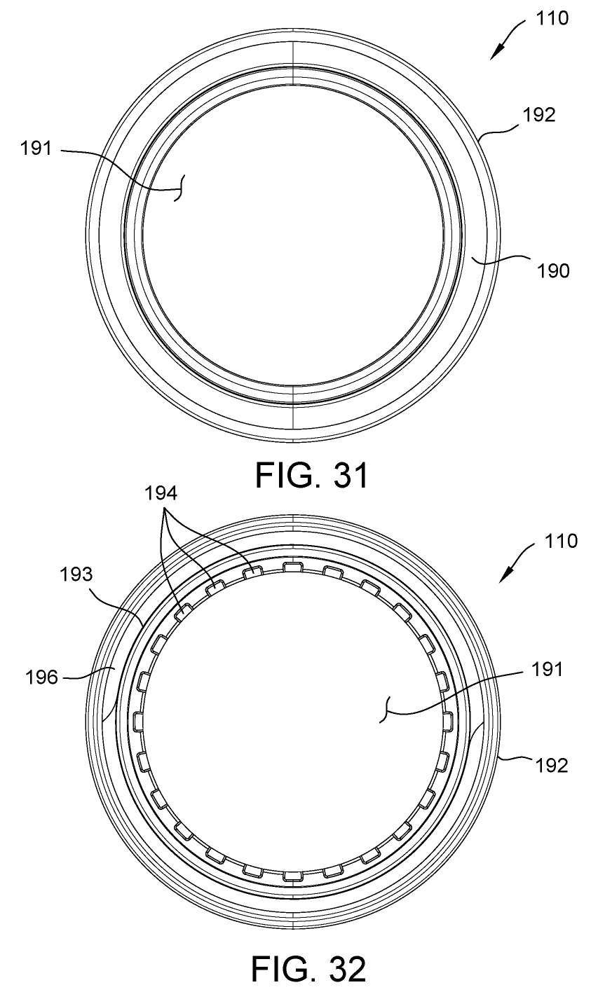

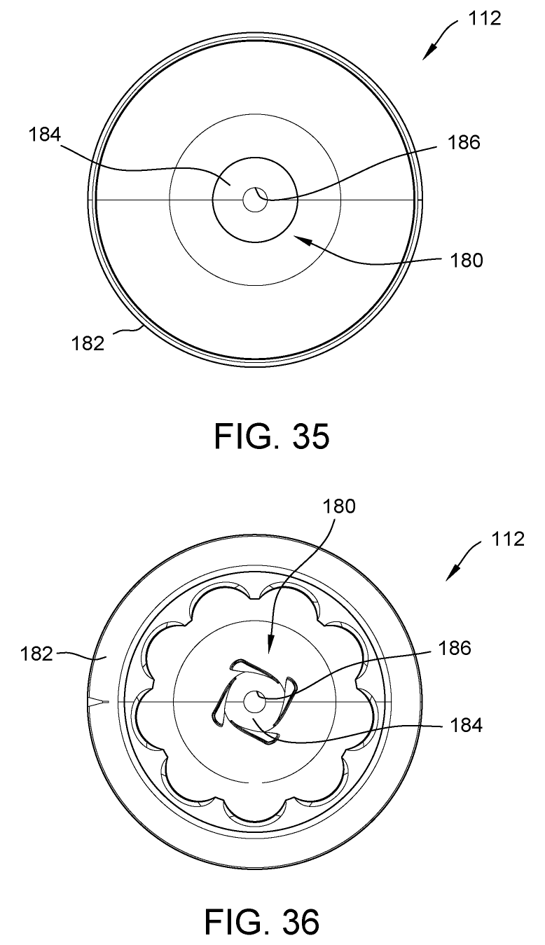

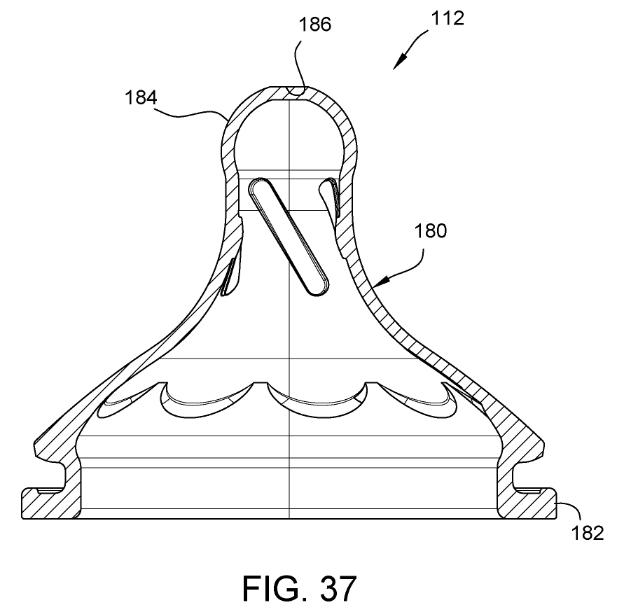

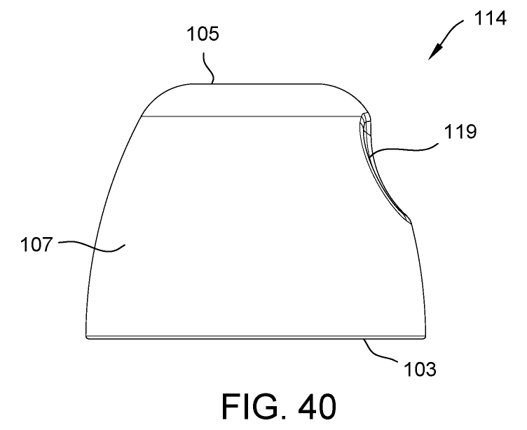

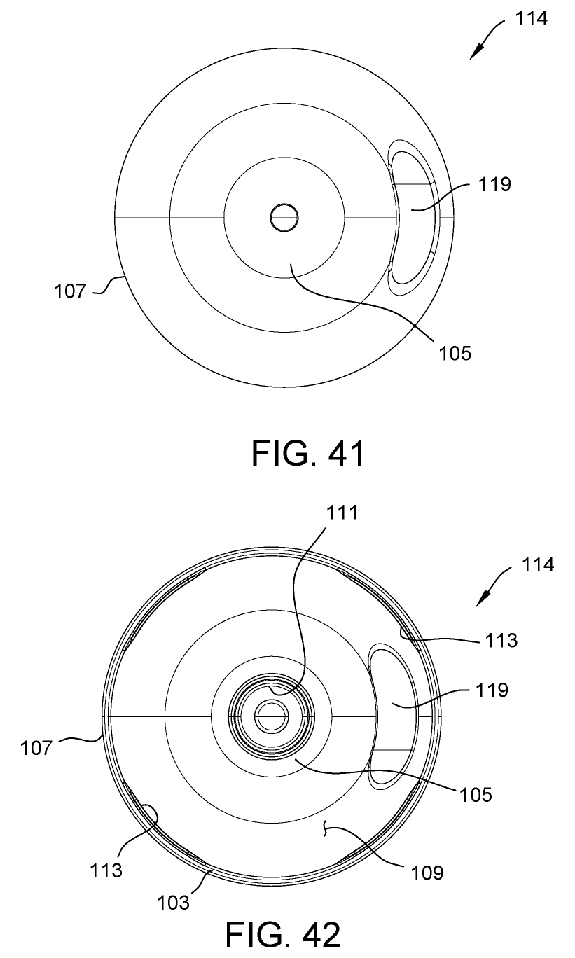

Referring now to FIGS. 1-42 and in particular to FIGS. 1-9, a nursing bottle assembly of one suitable embodiment of the present disclosure is generally indicated at 100. The illustrated nursing bottle assembly includes a container 102 (such as a collapsible silicone container and more particularly a collapsible silicone nursing container as seen in the illustrated embodiment), a sleeve 104, a lower support 106, and a collar assembly, which is generally indicated at 108 in FIG. 2, for generally closing the bottle assembly and more specifically, the container. The collar assembly 108 comprises a collar 110 and a nipple 112. The nursing bottle assembly 100 of the illustrated embodiment further includes a cap 114 that is selectively attachable to and detachable from the collar assembly 108 to selectively cover and uncover the nipple 112.

The container 102, the sleeve 104, the lower support 106, the collar 110, the nipple 112, and the cap 114 can be selectively assembled and disassembled by a user to facilitate use of the nursing bottle assembly 100 and cleaning of the nursing bottle assembly. The nursing bottle assembly 100 of the present disclosure is dishwasher safe and able to be heated sufficiently to warm the contents of the nursing bottle assembly 100 or chilled to sufficiently cool or even freeze the contents of the nursing bottle assembly. For example, the nursing bottle assembly 100 seen in the accompanying drawings can be heated to a temperature to sufficiently warm breast milk or infant formula. It is contemplated, however, that the liquid can be warmed in a different container and poured in the container 102 of the nursing bottle assembly 100. It is also contemplated that the nursing bottle assembly can be cooled or even placed in the freezer, and that it can receive cooled liquids and ice.

It is understood that bottle assembly of the present disclosure may be configured other than as a nursing bottle assembly 100 as illustrated and described herein, such as a sippy cup, a straw cup, a sports bottle, a drink tumbler, a training cup, a commuter cup, etc. It is also contemplated that, in some embodiments, the nursing bottle assembly 100 of the illustrated embodiment can be converted to another bottle assembly configuration (e.g., a training cup, a sippy cup, a straw cup) by replacing the collar assembly 108 of the nursing bottle assembly with a collar assembly having a different configuration. The components of the nursing bottle assembly 100 can be made from any suitable materials, provided in any desired color or colors, provided with or without patterns or textures, and may be transparent, translucent, opaque, or any combinations thereof.

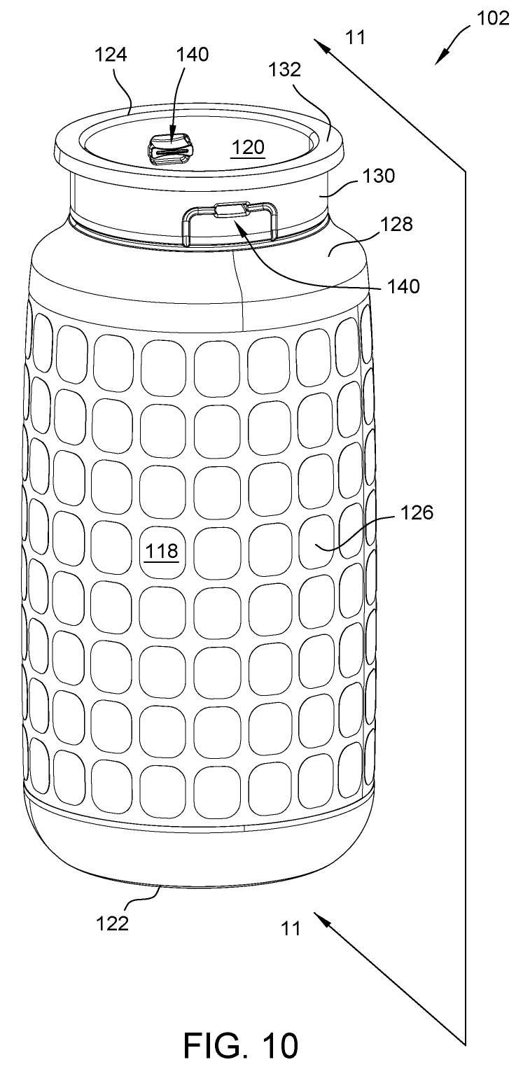

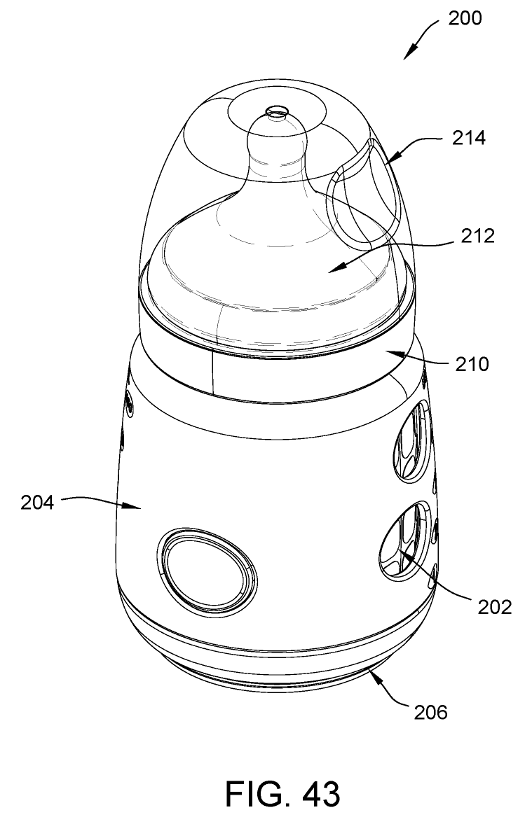

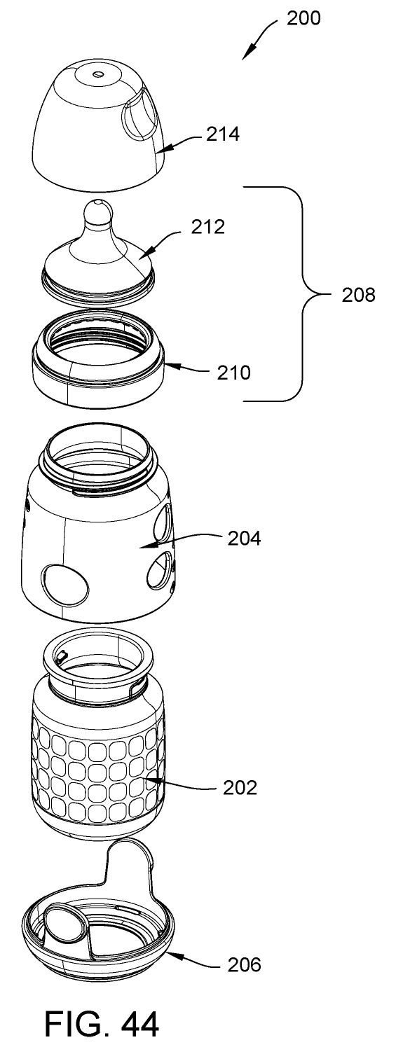

With reference now to FIGS. 10-18, the container 102 of the nursing bottle assembly 100 defines a liquid chamber 116 suitable for holding a quantity of liquid (such as breast milk or infant formula). In the illustrated embodiment, for example, the container 102 is sized to hold approximately 9 ounces (oz) of liquid. It is understood, however, that the container and thus, the nursing bottle assembly, can be sized to hold any suitable quantity of liquid including, but not limited to 2 oz, 3 oz, 4 oz, 5 oz, 6 oz, 7 oz, 8 oz, 9 oz, 10 oz, 12 oz, 15 oz, 16 oz, 20 oz, 24 oz, 28 oz, 30 oz, 32 oz, 48 oz etc. For example, FIGS. 43 and 44 illustrate another suitable embodiment of a nursing bottle assembly of the present disclosure, indicated generally at 200, sized to hold approximately 5 oz of liquid.

With reference still to FIGS. 10-18, the container 102 has an exterior surface 118, an interior surface 120, a closed bottom 122, an open top 124, and a generally cylindrical side wall 126 extending from the closed bottom. The container 102 further includes a shoulder 128, a neck 130, and a rim 132. The rim 132, which is generally ring shaped, defines the open top 124 of the container 102 and has an annular groove 134 extending circumferentially about its lower surface. The neck 130 extends from the rim 132 to the shoulder 128. The neck 130, in the illustrated embodiment of the container 102, is generally cylindrical and has an outer diameter that is less than an outer diameter of the cylindrical side wall 126. The shoulder 128 tapers inward from the cylindrical side wall 126 to the neck 130. It is understood, in other suitable embodiments, the outer diameter of the neck 130 may only be slightly smaller than the outer diameter of the side wall 126, or even the same diameter as the side wall, or slightly larger than the outer diameter of the side wall, without departing from some aspects of this disclosure. In an embodiment with the outer diameter of the neck being equal to the outer diameter of the side wall 126, the shoulder 128 can be omitted such that the neck and the side wall cooperatively define a continuous cylinder.

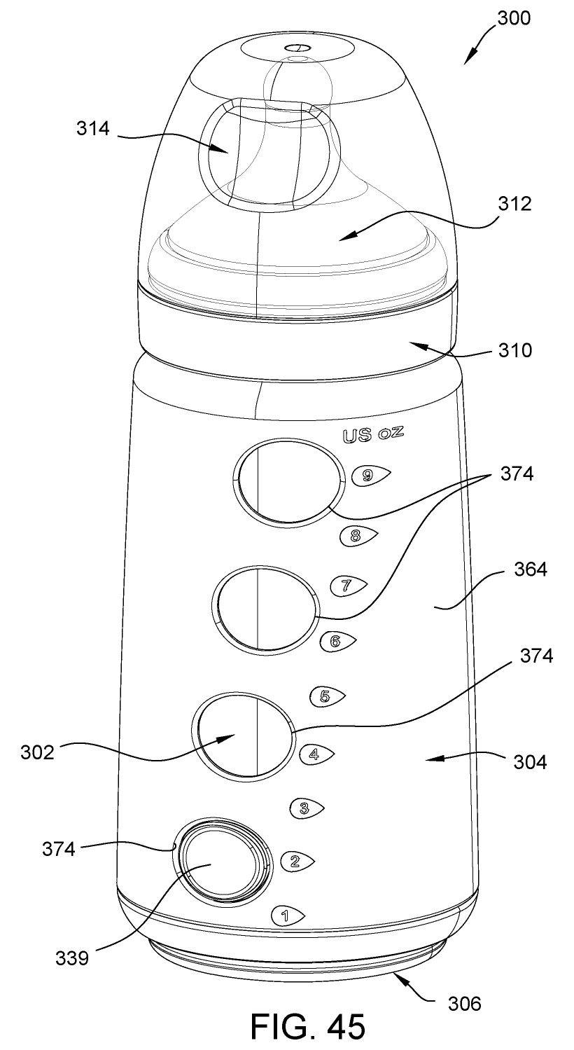

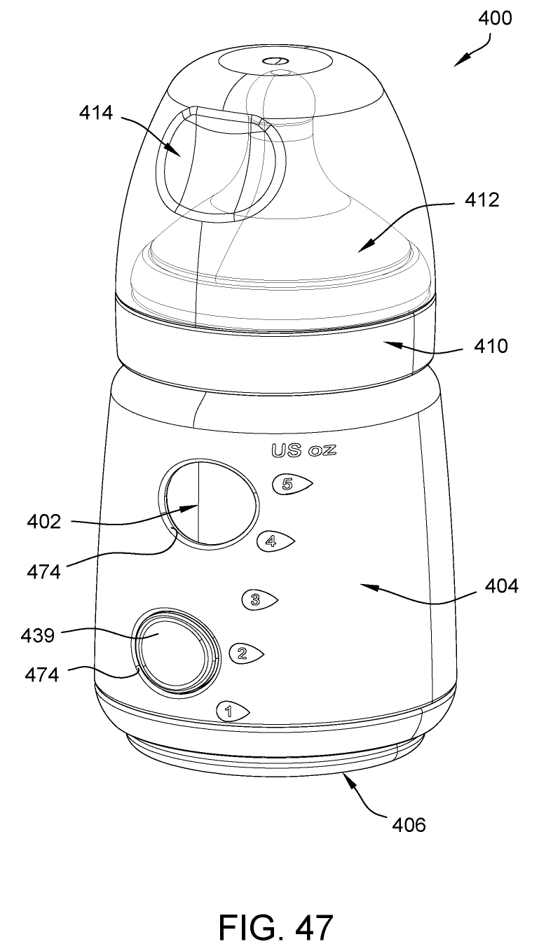

In the illustrated embodiment, the exterior surface 118 of the container 102 includes a surface pattern or a surface texture and, more specifically, a surface pattern or surface texture that includes a plurality of squares. It is understood that the exterior surface 118 of the container 102 can include any suitable surface pattern or surface texture. In one suitable embodiment, the surface pattern or surface texture on the exterior surface 118 of the container 102 facilitates gripping of the container by the user. It is understood, however, the exterior surface 118 of the container 102 can be free of any surface pattern or surface texture. In other words, the exterior surface 118 of the container 102 can be generally smooth as illustrated in the embodiments seen in FIGS. 45-48.

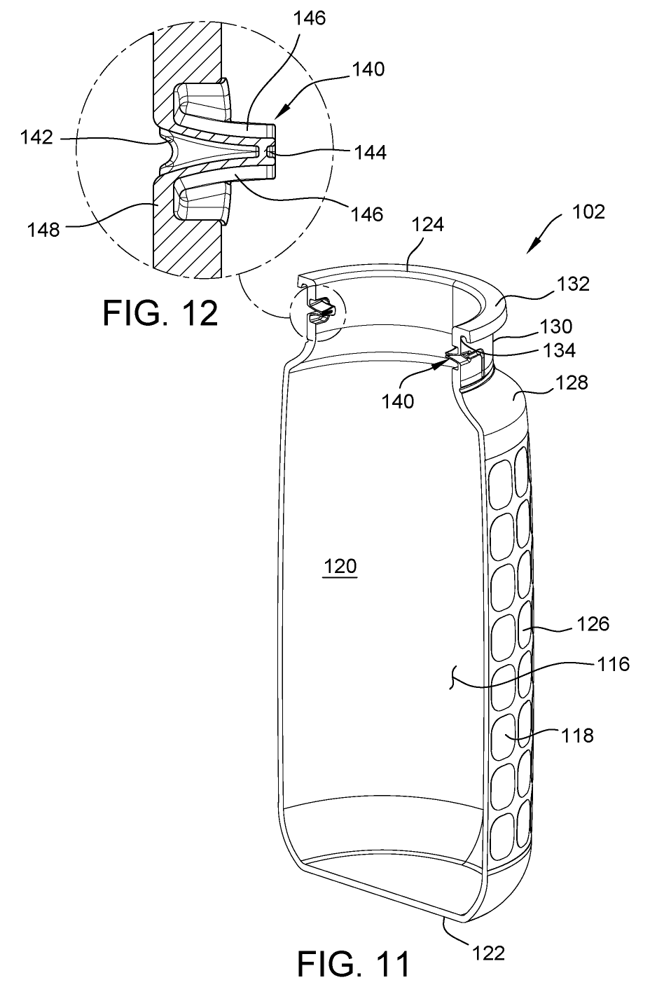

As seen in FIGS. 11-16, the neck 130 of the container 102 includes at least one vent, which in the illustrated embodiment is a duckbill valve, indicated at 140, that extends though the container 102 from the exterior surface 118 to the interior surface 120. Thus, the at least one vent provides a passageway for air from exterior the container 102 to pass through the vent and into the liquid chamber 116 as described in more detail below. It is contemplated that other types of valves (e.g., round shape valves, umbrella valves, diaphragm slit valves) or venting structures can be used to vent the container 102 and, more broadly, the nursing bottle assembly 100, without departing from some aspects of this invention. It is also contemplated that any suitable number of vents can be used, including one, two, three, four, etc. vents, and that the vent(s) can be disposed at any suitable location on the container 102 without departing from some aspects of this invention. In the illustrated embodiment of the nursing bottle assembly 100, for example, two duckbill valves 140 are disposed on the neck 130 of the container 102.

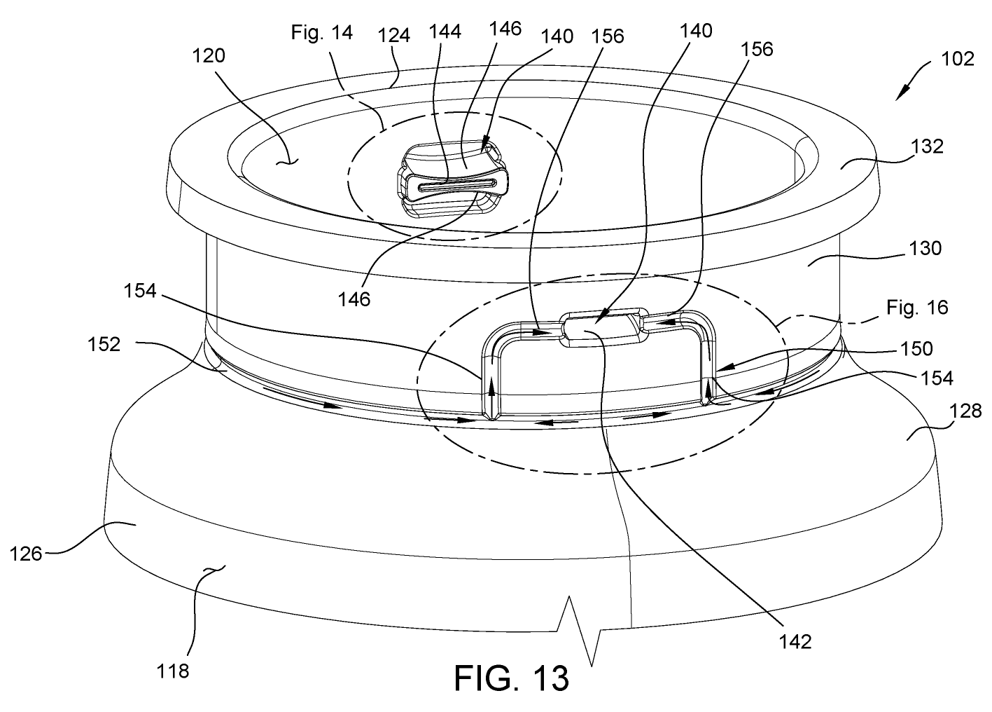

As best seen in FIGS. 11 and 13, the duckbill valves 140 of the illustrated container 102 are disposed in opposed relationship to each other on the neck 130 of the container 102. FIGS. 13 and 16 illustrate one of the duckbill valves 140 as viewed looking at the exterior surface 118 of the container 102, and FIGS. 13-15 illustrate the other duckbill valve as viewed looking at the interior surface 120 of the container. Each of the duckbill valves 140, which is a type of one-way valve, have an air inlet for allowing air (ambient air) to flow into the liquid chamber 116 of the container 102 while preventing air or liquid within the liquid chamber from exiting or leaking from the container and thus, the nursing bottle assembly 100 through the duckbill valves.

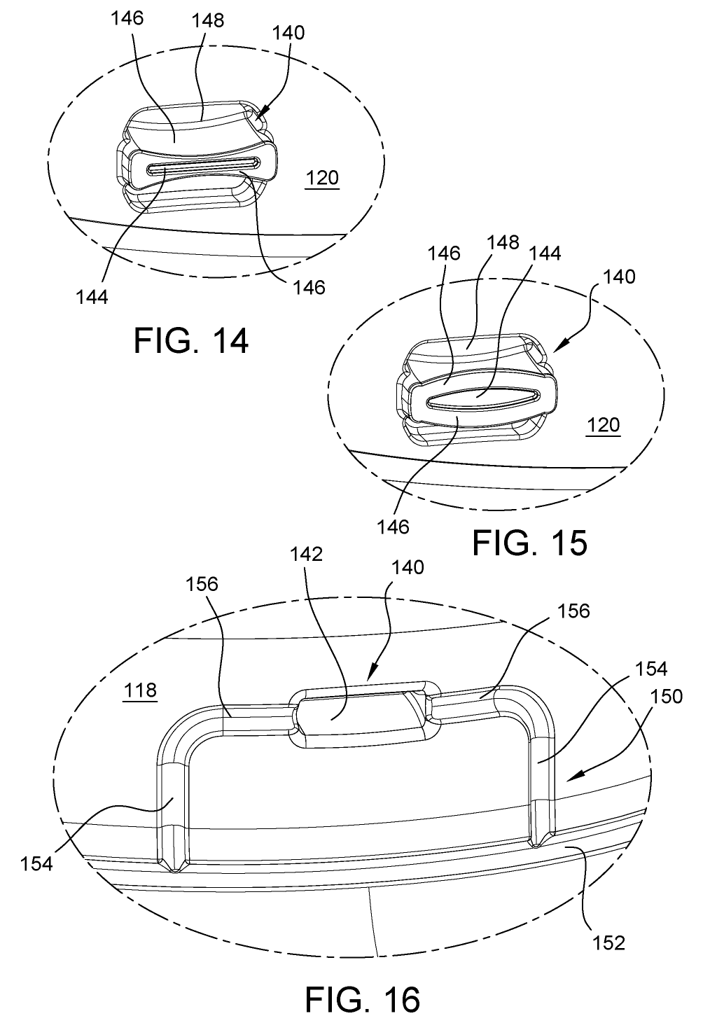

As seen in FIGS. 12-16, each of the duckbill valves 140 includes an inlet 142 for allowing air to enter the valve and an outlet 144 for allowing air that entered in the inlet to exit the valve. The outlet 144 of each of the duckbill valves 140 include a pair of flexible, elastomeric flaps 146 that are hinged at one end. These flaps 146 are made from suitable materials (e.g., rubber, silicone, other elastomers) that can readily flex and move. In the closed position, which is illustrated in FIGS. 12 and 14, the flaps 146 and more specifically edges of the flaps meet and form a liquid tight seal and, more suitably, a liquid and an airtight seal under ambient conditions. In the opened position, which is illustrated in FIG. 15, the edges of the flaps 146 of the duckbill valve 140 separate thereby allowing air to flow therethrough. As seen best in FIG. 12, the flaps 146 are supported in the neck 130 of the container 102 by a suitable valve support web 148.

In the illustrated embodiment, each of the duckbill valves 140 are configured to move from the closed position (FIGS. 12 and 14) to the opened position (FIG. 15) upon a vacuum pressure inside the liquid chamber 116 of the container 102 reaching a predetermined threshold. More specifically, at least one of the duckbill valves 140 will move to the open position when the pressure differential between the liquid chamber 116 of the container 102, which will be subjected to a vacuum pressure during normal use as liquid is drawn from the liquid chamber, and ambient pressure, which under normal conditions will be a positive pressure, reaches the predetermined threshold. As long as the pressure differential across the duckbill valve 140 is at or above the predetermined threshold, the duckbill valve will remain in the opened position, and air will enter the liquid chamber 116 of the container 102. Once the pressure inside the liquid chamber 116 raises above the predetermined threshold, the duckbill valve 140 will move to the closed position thereby stopping the flow of air into the liquid chamber.

For purposes of this disclosure, a typical range for ambient pressure is considered to be between 28.5 to 30.7 inches of mercury, with the standard sea level pressure being 29.9 inches of mercury. In one suitable embodiment, each of the duckbill valves 140 can be configured such that between 2-30 millimeters of mercury vacuum pressure can move the valves from the closed position to the opened position.

A vent passage, indicated at 150, is formed on the exterior surface 118 of the neck 130 of the illustrated container 102 and provides a passageway for air exterior of the container to enter the liquid chamber 116 through the duckbill valves 140. In other words, the vent passage 150 fluidly connects each of the inlets 142 of the duckbill valves 140 to ambient air (air exterior the container 102). With reference to FIG. 13, the vent passage 150 includes an annular passage 152 that extends circumferentially around the neck 130 of the container 102 adjacent the shoulder 128, a pair of upward extending passages 154, and a pair of lateral passages 156 that connect the upward passages to the inlet 142 of the respective duckbill valve 140.

The container 102 of the illustrated nursing bottle assembly 100 of the present disclosure is made from a collapsible, silicone material. Suitably, the container 102 is made of high-quality, food-grade silicone, which is BPA-free, non-toxic, and otherwise safe for holding drinking liquids. The silicone material of the container 102 is soft, flexible, and durable. As mentioned above, the container is suitably made of a material that can heated and cooled, and accept both heated liquids (e.g., heated breastmilk or infant formula) and cooled liquids (e.g., water or fruit juice).

As liquid contained within the liquid chamber 116 of the container 102 is withdrawn (for example, by a user drinking liquid within the liquid chamber), the container collapses, which gradually reduces the internal volume of the liquid chamber. As the liquid within the liquid chamber 116 is initially removed, the flexible silicone allows the container 102 to collapse thereby reducing the internal volume of the liquid chamber. The initial collapse of the container 102 will generally maintain the pressure within the liquid chamber 116 of the container at or near ambient pressure. However, as more liquid is drawn from the liquid chamber 116, the container 102 continues to collapse. As liquid continues to be withdrawn, the liquid chamber 116 of the container 102 becomes subject to increased vacuum pressure. Once the increased vacuum pressure within the liquid chamber 116 reaches the predetermined threshold, at least one of the duckbill valves 140 open thereby allowing ambient air to pass through the duckbill valve as described above and enter the liquid chamber of the container 102, which restores the pressure within the liquid chamber to ambient pressure or close thereto. Once the pressure within the liquid chamber 116 is returned to or close to the ambient pressure, any of the duckbill valves 140 that had moved to the opened position move back to the closed position, which is the normal position of the duckbill valves. The opening and closing of the duckbill valves 140 in the neck 130 of the illustrated container 102 continue as necessary during the removal of liquid from the liquid chamber 116 of the container. As can be appreciated, the duckbill valves 140 of the container 102 suitably vent the liquid chamber 116 of the container 102 during use and thereby inhibit air locking and otherwise allow more of the liquid within the liquid chamber of the container to be consumed to the drinker.

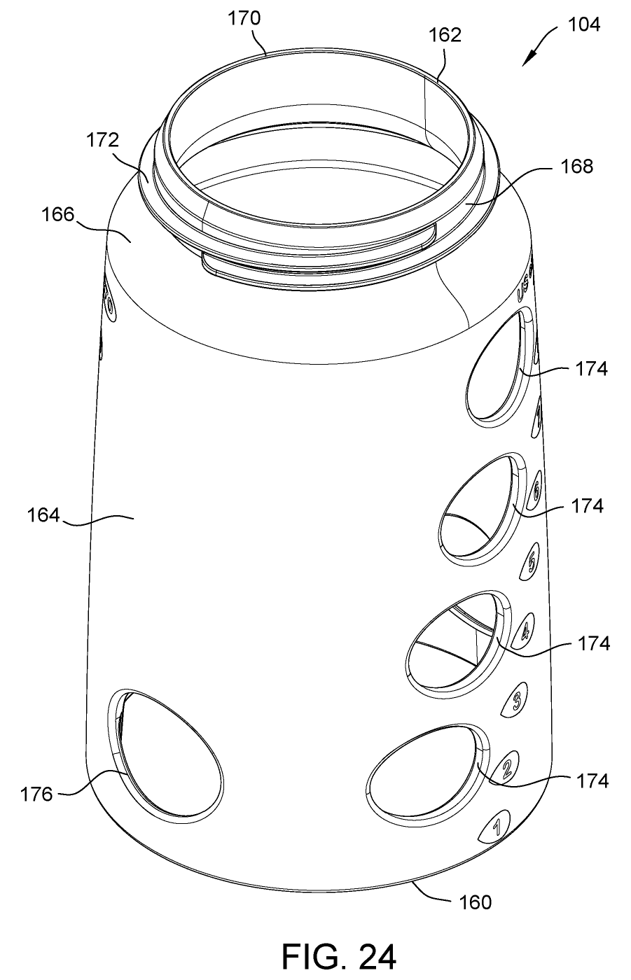

Now referring to FIGS. 24-28, the sleeve 104 of the illustrated nursing bottle assembly 100 is sized and shaped to substantively capture and overlay the container 102. The sleeve 104, which is more rigid than the container 102, includes an opened bottom 160, an open top 162, and a generally cylindrical side wall 164 extending from the opened bottom. The sleeve 104 further includes a shoulder 166, a threaded neck 168, and a rim 170. The rim 170 defines the open top 162 of the sleeve 104. The threaded neck 168, which includes threads 172, extends between the rim 170 and the shoulder 166. The threaded neck 168 is generally cylindrical and has an outer diameter that is less than an outer diameter of the cylindrical side wall 164. The shoulder 166 tapers inward from the cylindrical side wall 164 to the neck 168.

The sleeve 104 of the illustrated embodiment includes a plurality of windows 174 in the side wall 164 thereof so that the underlying container 102 and thus the contents of the container can be visually observed. In the illustrated embodiment, the sleeve 104 has eight windows 174. Four of the windows 174 are disposed on one side of the sleeve 104 and the other four windows are disposed on the opposite side of the sleeve. It is understood that the sleeve 104 can have any suitable number of windows 174. It is also understood that the sleeve 104 could be devoid or free of windows 174. The sidewall 164 of the sleeve 104 also includes a pair of opposed openings 176 located adjacent the open bottom 160 of the sleeve. In the illustrated embodiment, the openings 176 are generally circular, but it is understood that the openings can have any suitable shape.

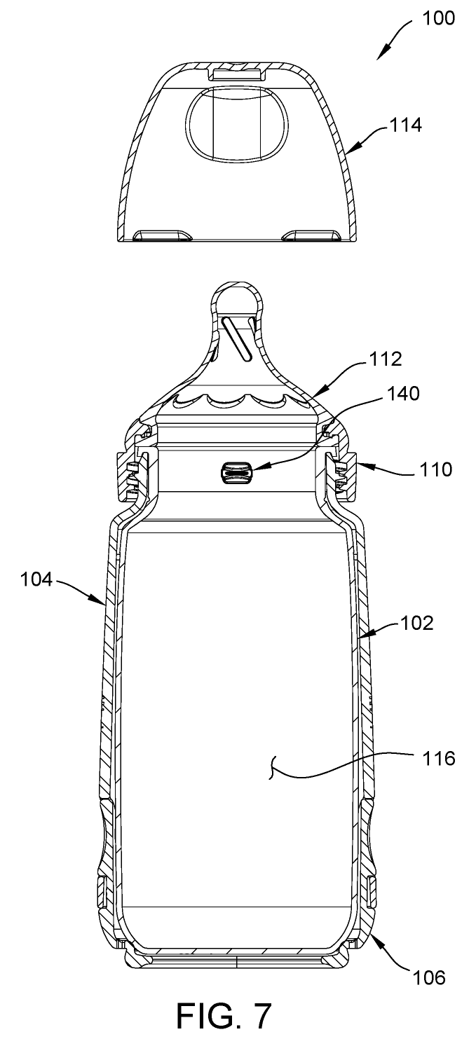

As illustrated best in FIG. 7, the sleeve 104 is adapted to selectively receive and capture the container 102. With the container 102 captured by the sleeve 104, the rim 170 of the sleeve is seated within the annular groove 134 of the lower surface of the rim 124 of the container 102. The neck 168, shoulder 166, and side wall 164 of the sleeve 104 generally overly the neck 130, shoulder 128 and side wall 126 of the container 102. The closed bottom 122 of the container 102 extends beyond the opened bottom 160 of the sleeve 104.

In one suitable embodiment, the sleeve 104 comprises an insulating material to at least partially insulate the container 102 to inhibit the cooling of warmed liquids placed in the liquid compartment of the container or warming of chilled liquids placed in the liquid compartment of the container.

With reference again to FIGS. 1-7, the collar assembly 108 of the illustrated nursing bottle assembly 100 is adapted for removable attachment to the sleeve 104 for selectively holding the nipple 112 on the container 102. The illustrated collar assembly 108, which as mentioned above includes the nipple 112 and the collar 110, can be made of any suitable material. In one embodiment, for example, the nipple 112 is made of a substantially pliable material such as at least one of a rubber material, a silicone material, and a latex material, and the collar 110 is made of polypropylene. The nipple 112 and the collar 110 can be made in any desired color or colors, and may be transparent, translucent, or opaque.

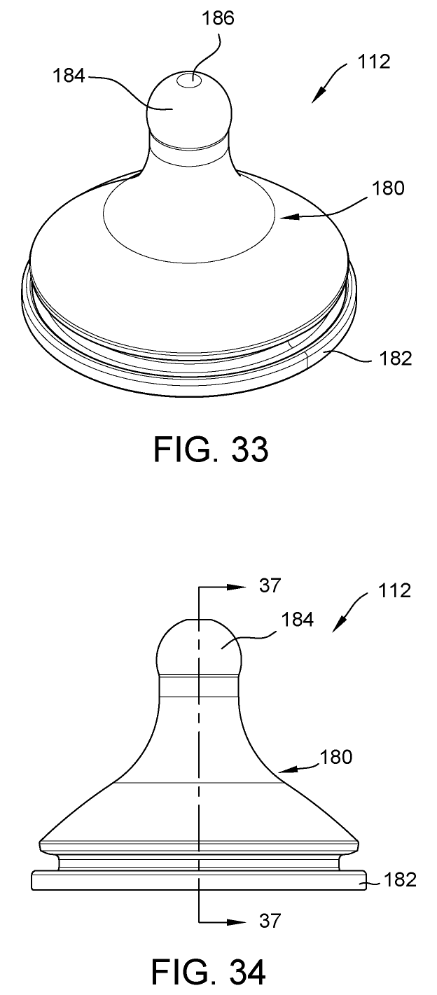

With reference to FIGS. 33-36, in the illustrated embodiment, the nipple 112 includes a nipple portion, indicated at 180, and a transversely extending flange 182. The nipple portion 180 includes an outlet end 184 including an aperture 186 for dispensing liquid to the user. It is contemplated, however, that the nipple 112 can have different shapes and sizes than those illustrated and described herein without departing from the present disclosure.

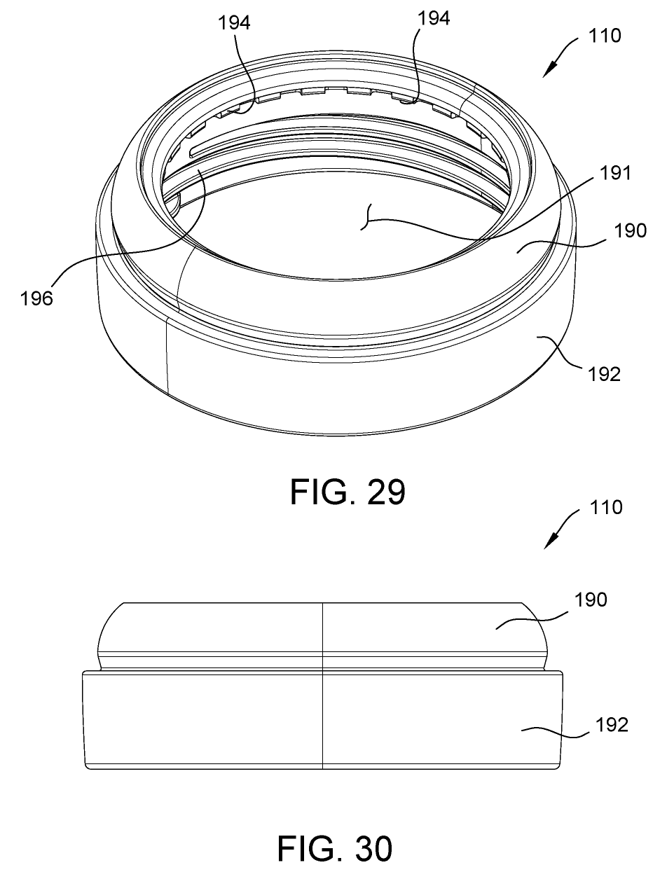

As shown in FIGS. 29-32, the collar 110 has an annular, tapered top panel 190 defining a central opening 191 and a depending side wall 192. The top panel 190 includes an annular projection 193 that extends downward from the underside of the panel proximate the central opening 191 and a plurality of notches 194. The central opening and the projection 193 facilitate assembly of the nipple 112 on the collar 110. To assemble the collar assembly 108, the nipple 112 is pulled, nipple portion 180 first, up through the central opening 191 in the top panel 190 of the collar 110 until flange 182 is positioned in engagement with the projection 193 of the collar. It is understood, however, that the nipple 112 and collar 110 may be configured other than as illustrated. It is also contemplated that in other embodiments of the collar assembly 108, the nipple 112 and collar 110 can be joined as a single piece.

The side wall 192 of the collar 110 has internal threads 196 for threaded engagement with the external threads 172 of the neck 168 of the sleeve 104 to releasably secure the collar and hence the collar assembly 108 on the sleeve. In some embodiments, the number of threads 196 on the side wall 192 of the collar exceeds the number of external threads 172 on the neck 168 of the sleeve 104. In one embodiment, for example, the collar 110 may have approximately twice as many internal threads 196 as the number of external threads 172 on the neck 168 of the sleeve 104.

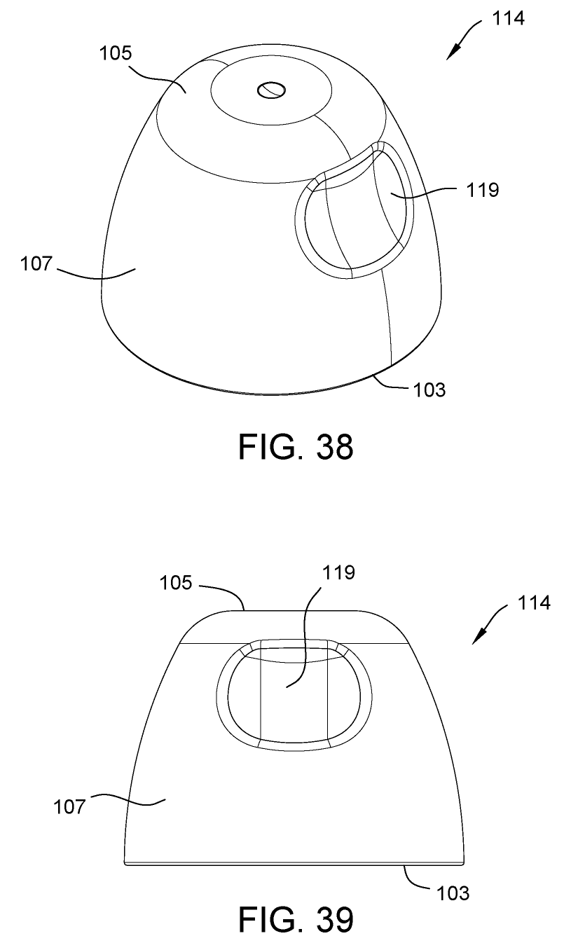

As seen in FIGS. 38-42, the nursing bottle assembly 100 of the illustrated embodiment also includes the cap 114 for covering the nipple 112 when the bottle assembly 100 is not in use. The cap 114 includes an open end 103, a closed end 105, and a side wall 107 extending between the open end 103 and the closed end 105. The side wall 107 and the closed end 105 define an interior space 109 sized and shaped to receive the nipple 112 therein. In the illustrated embodiment, the cap 114 is a dome. Specifically, the side wall 107 generally curves along the extension between the open end 103 and the closed end 105 such that the open end 103 has a greater diameter than the closed end 105. Accordingly, the side wall 107 has a generally convex curve when viewed from the exterior of the cap 114. In other embodiments, the cap 114 may have any shape that enables the cap 114 to function as described.

The cap 114 may be positioned on the collar assembly 108 such that at least a portion of the collar assembly extends through the open end 103 and into the interior space 109. Specifically, the nipple 112 is arranged to extend into the interior space 109 when the cap 114 is positioned on the collar assembly 108. At least one projection 111 extend downward from the center of the closed end 105 to engage the nipple 112 and inhibit displacement of the nipple when the cap 114 covers the nipple. In addition, the side wall 107 of the cap 114 includes latches 113 extending along the open end 103 that engage the collar 110. The latches 113 extend radially inward from an inner surface of the side wall 107.

In the illustrated embodiment, the cap 114 and the collar 110 are configured for a releasable snap-fit engagement. Specifically, to secure the cap 114 to the collar assembly 108, the user positions the cap 114 on the collar assembly 108 and presses in a direction toward the collar 110. Due to the pressing force, the cap 114 deforms slightly and allows the latches 113 to engage the collar 110. To remove the cap 114 from the collar assembly 108, the user presses or pulls the cap away from the collar assembly 108 and the latches 113 disengage from the collar 110. In other embodiments, the cap 114 may be secured to the collar 110, or more broadly the collar assembly 108, in any suitable manner.

In the illustrated embodiment, the side wall 107 of the cap 114 includes a curved surface defining a recess 119. The curved surface has a radius of curvature that is different from the radius of curvature of the rest of the side wall 107. Specifically, the curved surface curves inward from the side wall 107 such that the recess 119 is concave relative to the exterior of the cap 114. The recess 119 is sized and shaped to receive a thumb or other finger. Suitably, the recess 119 is shaped and positioned to utilize the leverage of a person’s finger and allow for easier positioning of the cap 114 relative to the collar assembly 108.

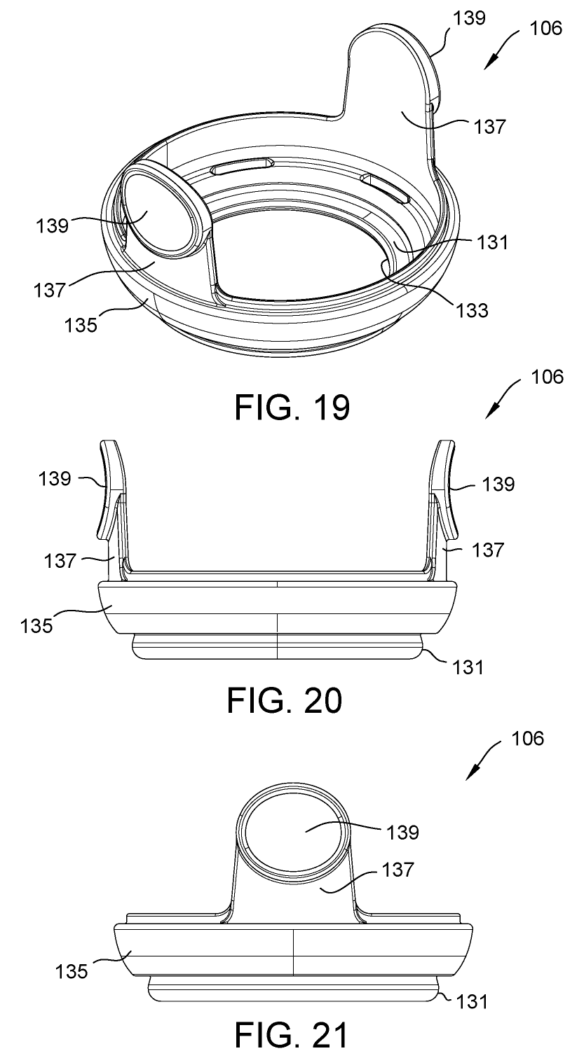

With reference to FIGS. 19-23, the lower support 106 comprises a lower annular ring 131, which includes an opening 133, that defines the bottom of the nursing bottle assembly 100 and provides a flat surface so that the nursing bottle assembly can be rested on a surface in an upright position. The lower annular ring 131 is sized and shaped to have a snap fit relationship with the cap 114. Thus, the cap 114 can be selectively placed into engagement with annular ring 131 and, more broadly, the lower support 106. Disposed above the lower annular ring 131, as seen in the accompanying drawings, is a tapered side wall 135 having a pair of risers 137 extending up from the side wall. Each of the risers 137 include a detent 139 sized and shaped for being captured by one of the openings 176 in the sleeve 104 to thereby secure the lower support 106 to the sleeve.

While the vent passageways 150 in the illustrated embodiment of the nursing bottle assembly 100 are illustrated and described as being located on the container 102 and, more specifically, the neck 130 of the container 102, it is contemplated that the vent passageways can be disposed on the collar assembly 108 including the collar 110 and/or the nipple 112 in addition to or instead of the vent passageways of the container.

As previously mentioned, FIGS. 43 and 44 illustrate another suitable embodiment of a nursing bottle assembly of the present disclosure, indicated generally at 200, sized to hold approximately 5 oz of liquid. The nursing bottle assembly 200 of this embodiment includes a container 202 (such as a collapsible silicone container and more particularly a collapsible silicone nursing container as seen in the illustrated embodiment of FIGS. 10-18), a sleeve 204, a lower support 206, and a collar assembly, which is generally indicated at 208 in FIG. 44, for generally closing the bottle assembly and more specifically, the container. The collar assembly 208 comprises a collar 210 and a nipple 212. The nursing bottle assembly 200 of the illustrated embodiment further includes a cap 214 that is selectively attachable to and detachable from the collar assembly 208 to selectively cover and uncover the nipple 212. The container 202, the sleeve 204, the lower support 206, the collar 210, the nipple 212, and the cap 214 of this embodiment are substantially the same as those described above with respect to the respective container 102, the sleeve 104, the lower support 106, the collar 110, the nipple 112, and the cap 114 of the prior embodiment.

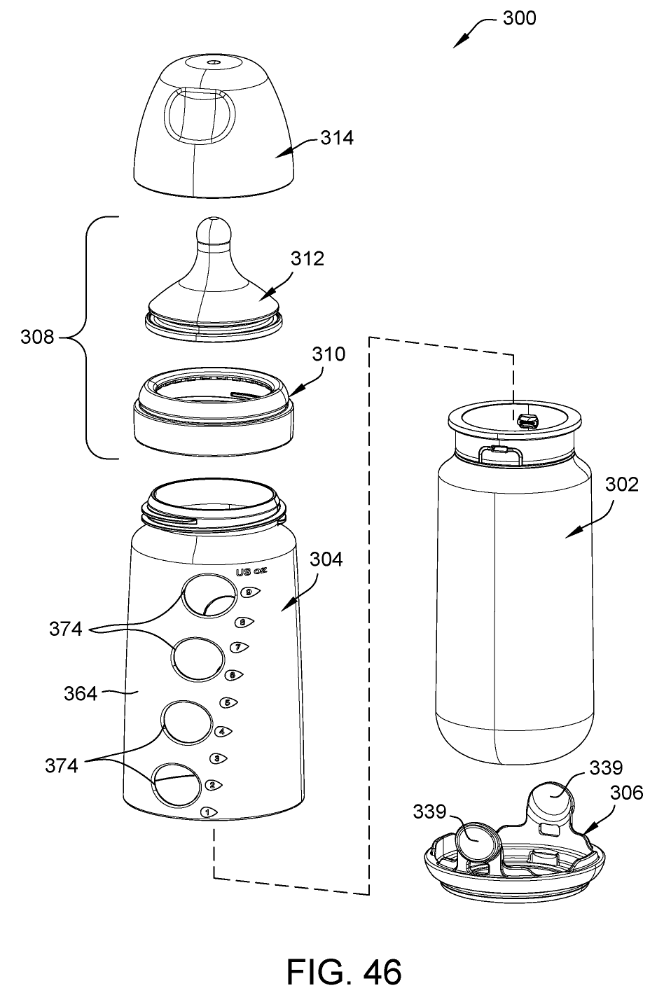

FIGS. 45 and 46 illustrate another suitable embodiment of a nursing bottle assembly of the present disclosure, indicated generally at 300, sized to hold approximately 9 oz of liquid. The nursing bottle assembly 300 of this embodiment includes a container 302 (such as a collapsible silicone container and more particularly a collapsible silicone nursing container as seen in the illustrated embodiment of FIGS. 10-18), a sleeve 304, a lower support 306, and a collar assembly, which is indicated at 308 in FIG. 46, for generally closing the bottle assembly and more specifically, the container. The collar assembly 308 comprises a collar 310 and a nipple 312. The nursing bottle assembly 300 of the illustrated embodiment further includes a cap 314 that is selectively attachable to and detachable from the collar assembly 308 to selectively cover and uncover the nipple 312. The sleeve 304 includes a side wall 364 having a plurality of windows 374 so that the underlying container 302 can be visually observed.

The container 302, the sleeve 304, the lower support 306, the collar 310, the nipple 312, and the cap 314 of this embodiment are substantially the same as those described above with respect to the respective container 102, the sleeve 104, the lower support 106, the collar 110, the nipple 112, and the cap 114 of the prior embodiment. However, the sleeve 304 of this embodiment is free of the pair of oppose openings 176 seen in embodiment of the sleeve 104 illustrated in FIG. 24. Rather, detents 339 of the lower support 306 are captured by one of the windows 374 in the side wall 364 of the sleeve 304 as illustrated in FIG. 45.

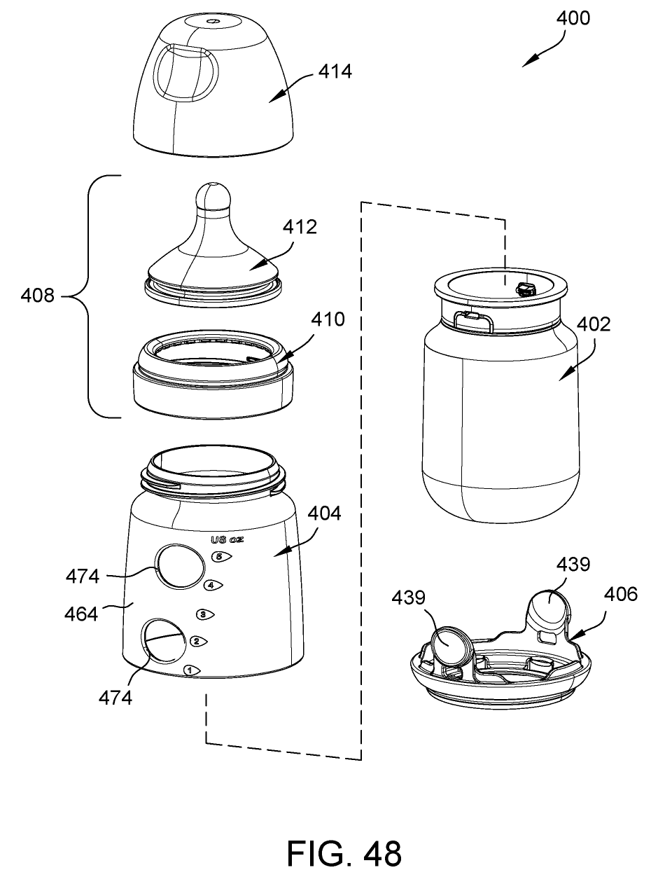

FIGS. 7 and 48 illustrate yet another suitable embodiment of a nursing bottle assembly of the present disclosure, indicated generally at 400, sized to hold approximately 5 oz of liquid. The nursing bottle assembly 400 of this embodiment includes a container 402 (such as a collapsible silicone container and more particularly a collapsible silicone nursing container as seen in the illustrated embodiment of FIGS. 10-18), a sleeve 404, a lower support 406, and a collar assembly, which is generally indicated at 408 in FIG. 48, for generally closing the bottle assembly and more specifically, the container. The collar assembly 408 comprises a collar 410 and a nipple 412. The nursing bottle assembly 400 of the illustrated embodiment further includes a cap 414 that is selectively attachable to and detachable from the collar assembly 408 to selectively cover and uncover the nipple 412. The sleeve 404 includes a side wall 464 having a plurality of windows 474 so that the underlying container 402 can be visually observed.

The container 402, the sleeve 404, the lower support 406, the collar 410, the nipple 412, and the cap 414 of this embodiment are substantially the same as those described above with respect to the respective container 102, the sleeve 104, the lower support 106, the collar 110, the nipple 112, and the cap 114 of the prior embodiment. Similar to the embodiment illustrated in FIGS. 45 and 46, the sleeve 404 of this embodiment is free of the pair of oppose openings 176 seen in embodiment of the sleeve 104 illustrated in FIG. 24. Rather, detents 439 of the lower support 406 are captured by one of the windows 374 in the side wall 364 of the sleeve 304.

When introducing elements of the present invention or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the invention, it is intended that all matter contained in the above description and shown in the accompanying drawings shall be interpreted as illustrative and not in a limiting sense.

What is claimed is:

1. A container for a bottle assembly, the container defining a liquid chamber and comprising an exterior surface, an interior surface, a closed bottom, an open top, a side wall extending from the closed bottom, and at least one vent for allowing air to enter the liquid chamber upon vacuum pressure within the liquid chamber reaching a predetermined threshold.

2. The container of claim 1 further comprising a shoulder, a neck, and a rim defining the open top, the at least one vent being disposed on the neck.

3. The container of claim 1 wherein the at least one vent comprises a duckbill valve.

4. The container of claim 1 wherein the at least one vent comprises a pair of duckbill valves.

5. The container of claim 2 wherein the at least one vent comprises a pair of duckbill valves, the duckbill valves being disposed in opposed relationship with each other about the neck.

6. The container of claim 2 wherein a vent passage is formed at least in part in the neck for facilitating air flow to the at least one vent.

7. The container of claim 6 wherein the vent passage comprises an annular passage that extends circumferentially around the neck of the container adjacent the shoulder, a pair of upward extending passages, and a pair of lateral passages that connect the upward passages to at least one vent.

8. The container of claim 1 wherein the container is made from a collapsible, silicone material.

9. A nursing bottle assembly comprising:
a container defining a liquid chamber and comprising an exterior surface, an interior surface, a closed bottom, an open top, a side wall extending from the closed bottom, and at least one vent for allowing air to enter the liquid chamber upon vacuum pressure within the liquid chamber reaching a predetermined threshold,
a sleeve for overlying and supporting the container; and
a collar assembly adapted for selective attachment to the sleeve for closing the nursing bottle assembly.

10. The nursing bottle assembly of claim 9 further comprising a lower support.

11. The nursing bottle assembly of claim 9 wherein the collar assembly comprises a collar and a nipple.

12. The nursing bottle assembly of claim 11 further includes a cap that is selectively attachable to and detachable from the collar assembly to selectively cover and uncover the nipple.

13. The nursing bottle assembly of claim 9 further comprising a shoulder, a neck, and a rim defining the open top, the at least one vent being disposed on the neck.

14. The nursing bottle assembly of claim 9 wherein the at least one vent comprises a duckbill valve.

15. The nursing bottle assembly of claim 14 wherein the at least one vent comprises a pair of duckbill valves, the duckbill valves being disposed in opposed relationship with each other about the neck.

16. The nursing bottle assembly of claim 13 wherein a vent passage is formed at least in part in the neck for facilitating air flow to the at least one vent.

17. The nursing bottle assembly of claim 16 wherein the vent passage comprises an annular passage that extends circumferentially around the neck of the container adjacent the shoulder, a pair of upward extending passages, and a pair of lateral passages that connect the upward passages to at least one vent.

18. A container for a bottle assembly, the container defining a liquid chamber and comprising an exterior surface, an interior surface, a closed bottom, an open top, a side wall extending from the closed bottom, and at least one vent for allowing air to enter the liquid chamber upon vacuum pressure within the liquid chamber reaching a predetermined threshold, the predetermined threshold being between 2 millimeters of mercury vacuum pressure and 30 millimeters of mercury vacuum pressure.

19. The container of claim 18 wherein the at least one vent comprises a duckbill valve.

20. The container of claim 19 wherein the at least one vent comprises a pair of duckbill valves, the duckbill valves being disposed in opposed relationship with each other on the container.
